(19) United States
(12) Patent Application Publication
(10) Pub. No.: US 2018/0102081 A1
(43) Pub. Date: Apr. 12, 2018

(54) DRIVING METHODS FOR ELECTRO-OPTIC DISPLAYS

(71) Applicant: E Ink Corporation, Billerica, MA (US)

(72) Inventors: Yi LU, Needham, MA (US); Theodore A. SJODIN, Lexington, MA (US); Chih-Hsiang HO, Andover, MA (US); Karl Raymond AMUNDSON, Cambridge, MA (US)

(21) Appl. No.: 15/726,864

(22) Filed: Oct. 6, 2017

Related U.S. Application Data
(60) Provisional application No. 62/405,875, filed on Oct. 8, 2016.

(51) Int. Cl. G09G 3/20; G09G 3/34; G02F 1/167

(52) U.S. Cl. CPC G09G 3/2014; G09G 3/3446; G09G 3/2018; G09G 3/2011; G02F 1/167

(57) ABSTRACT

A driving method an electro-optic display having a plurality of display pixels, the method include applying a first set of waveform to a first display pixel, the first set of waveform having at least one active portion configured to affect the optical state of the first display pixel and at least one non-active portion configured not to substantially affect the optical state of the first display pixel. The method also include applying a second set of waveform to a second display pixel, the second set of waveform having at least one active portion configured to affect the optical state of the second display pixel and at least one non-active portion configured not to substantially affect the optical state of the second display pixel, where the at least one active portions of the first and second set of waveforms do not overlap in time.

### SUBJECT OF THE INVENTION

This application claims benefit of U.S. Provisional Application 62/405,875 filed on Oct. 8, 2016. The entire disclosures of the aforementioned application is herein incorporated by reference.

### BACKGROUND OF INVENTION

The present invention relates to driving methods for electro-optic displays. More specifically, it is related to driving methods where pixel voltage shifts due to cross-talks may be effectively reduced.

The term “electro-optic” as applied to a material or a display, is used herein in its conventional meaning in the imaging art to refer to a material having first and second display states differing in at least one optical property, the material being changed from its first to its second display state by application of an electric field to the material. Although the optical property is typically color perceptible to the human eye, it may be another optical property, such as optical transmission, reflectance, luminescence or, in the case of displays intended for machine reading, pseudo-color in the sense of a change in reflectance of electromagnetic wavelengths outside the visible range.

The terms “bistable” and “bistability” are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in published US Patent Application No. 2002/0180687 (see also the corresponding International Application Publication No. WO 02/079869) that some particle-based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” may be used herein to cover both bistable and multi-stable displays.

The term “impulse” is used herein in its conventional meaning of the integral of voltage with respect to time. However, some bistable electro-optic media act as charge transducers, and with such media an alternative definition of impulse, namely the integral of current over time (which is equal to the total charge applied) may be used. The appropriate definition of impulse should be used, depending on whether the medium acts as a voltage-time impulse transducer or a charge impulse transducer.

Numerous patents and applications assigned to or in the names of the Massachusetts Institute of Technology (MIT) and E Ink Corporation have recently been published describing encapsulated electrophoretic media. Such encapsulated media comprise numerous small capsules, each of which itself comprises an internal phase containing electrophoretically-mobile particles suspended in a liquid suspension medium, and a capsule wall surrounding the internal phase. Typically, the capsules are themselves held within a polymeric binder to form a coherent layer positioned between two electrodes. The technologies described in these patents and applications include:
(a) Electrophoretic particles, fluids and fluid additives; see for example U.S. Pat. Nos. 7,002,728 and 7,679,814;
(b) Capsules, binders and encapsulation processes; see for example U.S. Pat. Nos. 6,922,276 and 7,411,719;
(c) Films and sub-assemblies containing electro-optic materials; see for example U.S. Pat. Nos. 6,982,178 and 7,839,564;
(d) Backplanes, adhesive layers and other auxiliary layers and methods used in displays; see for example U.S. Pat. Nos. 7,116,318 and 7,535,624;
(e) Color formation and color adjustment; see for example U.S. Pat. Nos. 7,075,502 and 7,839,564;
(f) Methods for driving displays; see for example U.S. Pat. Nos. 5,930,026; 6,445,489; 6,504,524; 6,512,354; 6,531,997; 6,753,999; 6,825,970; 6,900,851; 6,995,550; 7,012,600; 7,023,420; 7,034,783; 7,061,166; 7,061,662; 7,116,466; 7,119,772; 7,177,066; 7,193,625; 7,202,847; 7,242,514; 7,259,744; 7,304,787; 7,312,794; 7,327,511; 7,408,699; 7,453,445; 7,492,339; 7,528,822; 7,545,358; 7,583,251; 7,602,374; 7,612,760; 7,679,599; 7,679,813; 7,683,606; 7,688,297; 7,729,039; 7,733,311; 7,733,335; 7,787,169; 7,859,742; 7,952,557; 7,956,841; 7,982,479; 7,999,787; 8,077,141; 8,125,501; 8,139,050; 8,174,490; 8,243,013; 8,274,472; 8,289,250; 8,300,006; 8,305,341; 8,314,784; 8,373,649; 8,384,658; 8,456,414; 8,462,102; 8,537,105; 8,558,783; 8,558,785; 8,558,786; 8,558,855; 8,576,164; 8,576,259; 8,593,396; 8,605,032; 8,643,595; 8,665,206; 8,681,191; 8,730,153; 8,810,525; 8,928,562; 8,928,641; 8,976,444; 9,013,394; 9,019,197; 9,019,198; 9,019,318; 9,082,352; 9,171,508; 9,218,773; 9,224,338; 9,224,342; 9,224,344; 9,230,492; 9,251,736; 9,262,973; 9,269,311; 9,299,294; 9,373,289; 9,390,066; 9,390,661; and 9,412,314; and U.S. Patent Applications Publication Nos. 2003/0102858; 2004/0246562; 2005/0253777; 2007/0070032; 2007/0076289; 2007/0091418; 2007/0103427; 2007/0176912; 2007/0296452; 2008/0024429; 2008/0024482; 2008/0136774; 2008/0169821; 2008/0218471; 2008/0291129; 2008/0303780; 2009/0174651; 2009/0195568; 2009/0322721; 2010/0194733; 2010/0194789; 2010/0220121; 2010/0265561; 2010/0283804; 2011/0063314; 2011/0175875; 2011/0193840; 2011/0193841; 2011/0199671; 2011/0221740; 2012/0001957; 2012/0098740; 2013/0063333; 2013/0194250; 2013/0249782; 2013/0321278; 2014/0009817; 2014/0085355; 2014/0204012; 2014/0218277; 2014/0240210; 2014/0240373; 2014/0253425; 2014/0292830; 2014/0293398; 2014/0333685; 2014/0340734; 2015/0070744; 2015/0097877; 2015/0109283; 2015/0213749; 2015/0213765; 2015/0221257; 2015/0262255; 2016/0071465; 2016/0078820; 2016/0093253; 2016/0140910; and 2016/0180777;
(g) Applications of displays; see for example U.S. Pat. Nos. 6,118,426; 6,473,072; 6,704,133; 6,710,540; 6,738,050; 6,825,829; 7,030,854; 7,119,759; 7,312,784; and U.S. Pat. Nos. 8,009,348; 7,705,824; 8,064,962; and 8,553,012; and U.S. Patent Applications Publication Nos. 2002/0090980; 2004/0119681; and 2007/0285385; and International Application Publication No. WO 00/36560; and
(h) Non-electrophoretic displays, as described in U.S. Pat. Nos. 6,241,921; 6,950,220; 7,420,549 8,319,759; and 8,994,705 and U.S. Patent Application Publication No. 2012/0293858.
(i) Microcell structures, wall materials, and methods of forming microcells; see for example U.S. Pat. Nos. 7,072,095; 9,279,906;
(j) Methods for filling and sealing microcells; see for example U.S. Pat. Nos. 7,144,942 and 7,715,088;

Many of the aforementioned patents and applications recognize that the walls surrounding the discrete microcapsules in an encapsulated electrophoretic medium could be replaced by a continuous phase, thus producing a so-called polymer-dispersed electrophoretic display in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, the aforementioned 2002/0131147. Accordingly, for purposes of the present application, such polymer-dispersed electrophoretic media are regarded as sub-species of encapsulated electrophoretic media.

An encapsulated electrophoretic display typically does not suffer from the clustering and settling failure mode of traditional electrophoretic devices and provides further advantages, such as the ability to print or coat the display on a wide variety of flexible and rigid substrates. (Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; inkjet printing processes; and other similar techniques.) Thus, the resulting display can be flexible. Further, because the display medium can be printed (using a variety of methods), the display itself can be made inexpensively.

A related type of electrophoretic display is a so-called “microcell electrophoretic display”. In a microcell electrophoretic display, the charged particles and the suspending fluid are not encapsulated within microcapsules but instead are retained within a plurality of cavities formed within a carrier medium, typically a polymeric film. See, for example, International Application Publication No. WO 02/01281, and published U.S. Application No. 2002/0075556, both assigned to Sipix Imaging, Inc.

The aforementioned types of electro-optic displays are bistable and are typically used in a reflective mode, although as described in certain of the aforementioned patents and applications, such displays may be operated in a “shutter mode” in which the electro-optic medium is used to modulate the transmission of light, so that the display operates in a transmissive mode. Liquid crystals, including polymer-dispersed liquid crystals, are, of course, also electro-optic media, but are typically not bistable and operate in a transmissive mode. Certain embodiments of the invention described below are confined to use with reflective displays, while others may be used with both reflective and transmissive displays, including conventional liquid crystal displays.

Whether a display is reflective or transmissive, and whether or not the electro-optic medium used is bistable, to obtain a high-resolution display, individual pixels of a display must be addressable without interference from adjacent pixels. One way to achieve this objective is to provide an array of non-linear elements, such as transistors or diodes, with at least one non-linear element associated with each pixel, to produce an “active matrix” display. An addressing or pixel electrode, which addresses one pixel, is connected to an appropriate voltage source through the associated non-linear element. Typically, when the non-linear element is a transistor, the pixel electrode is connected to the drain of the transistor, and this arrangement will be assumed in the following description, although it is essentially arbitrary and the pixel electrode could be connected to the source of the transistor. Conventionally, in high resolution arrays, the pixels are arranged in a two-dimensional array of rows and columns, such that any specific pixel is uniquely defined by the intersection of one specified row and one specified column. The sources of all the transistors in each column are connected to a single column electrode, while the gates of all the transistors in each row are connected to a single row electrode; again the assignment of sources to rows and gates to columns is conventional but essentially arbitrary, and could be reversed if desired. The row electrodes are connected to a row driver, which essentially ensures that at any given moment only one row is selected, i.e., that there is applied to the selected row electrode a voltage such as to ensure that all the transistors in the selected row are conductive, while there is applied to all other rows a voltage such as to ensure that all the transistors in these non-selected rows remain non-conductive. The column electrodes are connected to column drivers, which place upon the various column electrodes voltages selected to drive the pixels in the selected row to their desired optical states. (The aforementioned voltages are relative to a common front electrode which is conventionally provided on the opposed side of the electro-optic medium from the non-linear array and extends across the whole display.) After a pre-selected interval known as the “line address time” the selected row is deselected, the next row is selected, and the voltages on the column drivers are changed to that the next line of the display is written. This process is repeated so that the entire display is written in a row-by-row manner.

Processes for manufacturing active matrix displays are well established. Thin-film transistors, for example, can be fabricated using various deposition and photolithography techniques. A transistor includes a gate electrode, an insulating dielectric layer, a semiconductor layer and source and drain electrodes. Application of a voltage to the gate electrode provides an electric field across the dielectric layer, which dramatically increases the source-to-drain conductivity of the semiconductor layer. This change permits electrical conduction between the source and the drain electrodes. Typically, the gate electrode, the source electrode, and the drain electrode are patterned. In general, the semiconductor layer is also patterned in order to minimize stray conduction (i.e., crosstalk) between neighboring circuit elements.

Liquid crystal displays commonly employ amorphous silicon (“a-Si”), thin-film transistors (“TFTs”) as switching devices for display pixels. Such TFTs typically have a bottom-gate configuration. Within one pixel, a thin film capacitor typically holds a charge transferred by the switching TFT. Electrophoretic displays can use similar TFTs with capacitors, although the function of the capacitors differs somewhat from those in liquid crystal displays; see the aforementioned copending application Ser. No. 09/565,413, and Publications 2002/0106847 and 2002/0060321. Thin film transistors can be fabricated to provide high performance. Fabrication processes, however, can result in significant cost.

In TFT addressing arrays, pixel electrodes are charged via the TFT's during a line address time. During the line address time, a TFT is switched to a conducting state by changing an applied gate voltage. For example, for an n-type TFT, a gate voltage is switched to a “high” state to switch the TFT into a conducting state.

Undesirably, the pixel electrode typically exhibits a voltage shift when the select line voltage is changed to bring the TFT channel into depletion. The pixel electrode voltage shift occurs because of the capacitance between the pixel electrode and the TFT gate electrode. The voltage shift can be modeled as:

$$Δ {V}_{p} = \frac{{C}_{gp}}{{C}_{gp} + {C}_{p} + {C}_{s}} Δ$$

where C_{gp} is the gate-pixel capacitance, Cₚ the pixel capacitance, Cₛ the storage capacitance and Δ is the fraction of the gate voltage shift when the TFT is effectively in depletion. This voltage shift is often referred to as “gate feedthrough”.

Gate feedthrough can be compensated by shifting the top plane voltage (the voltage applied to the common front electrode) by an amount ΔVₚ. Complications arise, however, because ΔVₚ varies from pixel to pixel due to variations of C_{gp} from pixel to pixel. Thus, voltage biases can persist even when the top plane is shifted to compensate for the average pixel voltage shift. The voltage biases can cause errors in the optical states of pixels, as well as degrade the electro-optic medium.

Variations in C_{gp} are caused, for example, by misalignment between the two conductive layers used to form the gate and the source-drain levels of the TFT; variations in the gate dielectric thickness; and variations in the line etch, i.e., line width errors.

Furthermore, additional voltage shifts may be caused by crosstalk occurring between a data line the pixel electrode. Similar to the voltage shift described above, crosstalk between the data line and the pixel electrode can be caused by capacitive coupling between the two even when the display pixel is not being addressed (e.g., associated pixel TFT in depletion). One example being data line supplying voltage lists or a set of driving waveforms to one pixel electrode can cause crosstalk with a neighboring pixel electrode not being driven due to the close proximity of the data line and the neighboring electrode. Such crosstalk can result in voltage shifts that are undesirable because it can lead to optical artifacts such as image streaking.

The voltage shift between the data line and the pixel electrode may be reduced by alter the geometrical dimensions of the pixel electrode and/or the data line. For example, the size of the pixel electrode may be reduced to enlarge the gap space between the electrode and the data line. In some other embodiments, the electrical properties of the material between the pixel electrode and the data line may be altered to reduce crosstalk. For example, one may increase the thickness of the insulating thin film between the pixel electrode and its neighboring data lines to reduce capacitive coupling. However, these methods can be expensive to implement and in some instances impossible due to design constraints such as device dimensional limitations. As such, there exists a need to reduce crosstalk in display pixels that is both easy and inexpensive to implement.

The present invention provides means to reduce crosstalk and voltage shifts in display pixels that can be conveniently applied to presently available display backplanes.

### SUMMARY OF INVENTION

This invention provides a method for driving an electro-optic display having a plurality of display pixels, the method including applying a first set of waveform to a first display pixel, the first set of waveform having at least one active portion configured to affect the optical state of the first display pixel and at least one non-active portion configured not to substantially affect the optical state of the first display pixel. The method also include applying a second set of waveform to a second display pixel, the second set of waveform having at least one active portion configured to affect the optical state of the second display pixel and at least one non-active portion configured not to substantially affect the optical state of the second display pixel, where the at least one active portions of the first and second set of waveforms do not overlap in time.

### BRIEF DESCRIPTION OF DRAWINGS

FIG. 1 illustrates a top view of a display pixel in accordance with the subject matter disclosed herein;

FIG. 2 illustrates exemplary driving Voltage Lists in accordance with the subject matter disclosed herein;

FIG. 3 illustrates alternative embodiments of the Voltage Lists illustrated in FIG. 2 for reducing pixel voltage shifts in accordance with the subject matter presented herein;

FIG. 4 illustrates a top view of a display pixel with a T-wire line in accordance with the subject matter presented herein;

FIG. 5 illustrates an exemplary driving Voltage List for the T-wire Line in accordance with the subject matter presented herein; and

FIG. 6 illustrates further embodiments of Voltage Lists in accordance with the subject matter presented herein.

### DETAILED DESCRIPTION

As indicated above, the present invention provides driving methods for electro-optic displays where crosstalk can be reduced. Such driving methods may include portions or segments where zero volt potential or bias is applied to a pixel electrode, in another word, during such portion or segment, the pixel electrode does not experience an optical shift or change.

It should be firstly appreciated that the methods described herein may be applied to an electro-optic display comprising a layer of electro-optic medium disposed on the backplane and covering the pixel electrode. Such an electro-optic display may use any of the types of electro-optic medium previously discussed or commonly adopted in the industry, for example, the electro-optic medium may be a liquid crystal, a rotating bichromal member or electrochromic medium, or an electrophoretic medium, preferably an encapsulated electrophoretic medium. In some embodiments, when an electrophoretic medium is utilized, a plurality of charged particles can move through a suspending fluid under the influence of an electric field. Such electrophoretic displays can have attributes of good brightness and contrast, wide viewing angles, state bistability, and low power consumption when compared with liquid crystal displays.

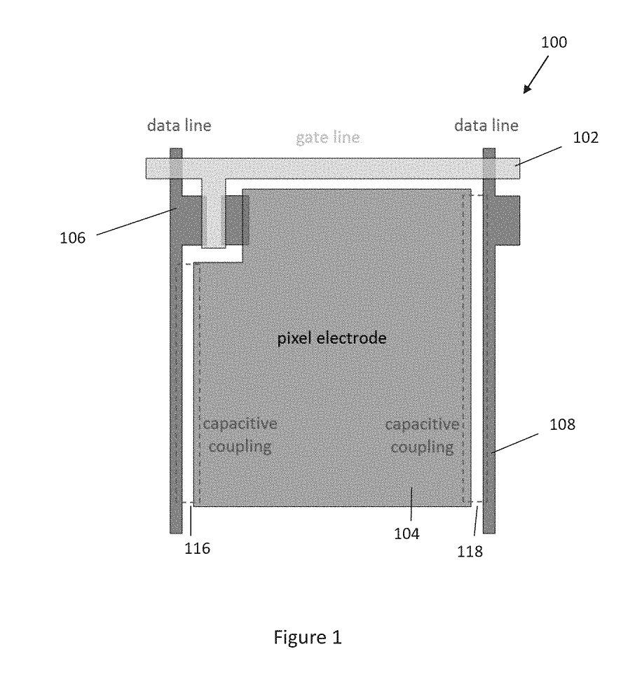

FIG. 1 illustrates a top view of an exemplary display pixel 100 using a TFT as means for switching. The pixel 100 can include a gate line 102 functioning as a source line to the display pixel and configured to supply switching signals to a pixel electrode 104. A data line 106 may be electrically coupled to the pixel electrode 104 and the gate line 102 for supplying driving signals (e.g., waveforms) or a voltage list to the pixel electrode 104. Voltage list are referred to herein as a set of waveforms or voltage values applied to the pixel over a period of time to effect the optical transition of the pixel from one gray level to a desired final gray level. Similarly, another data line 108 may be positioned adjacent to the pixel electrode 104 on an opposite side from the data line 104 for providing driving waveforms to a neighboring pixel electrode (not shown). From the top view illustrated in FIG. 1A, the data lines 106 and 108 are separated from the pixel electrode 104 by gap spaces 116 and 118 respectfully.

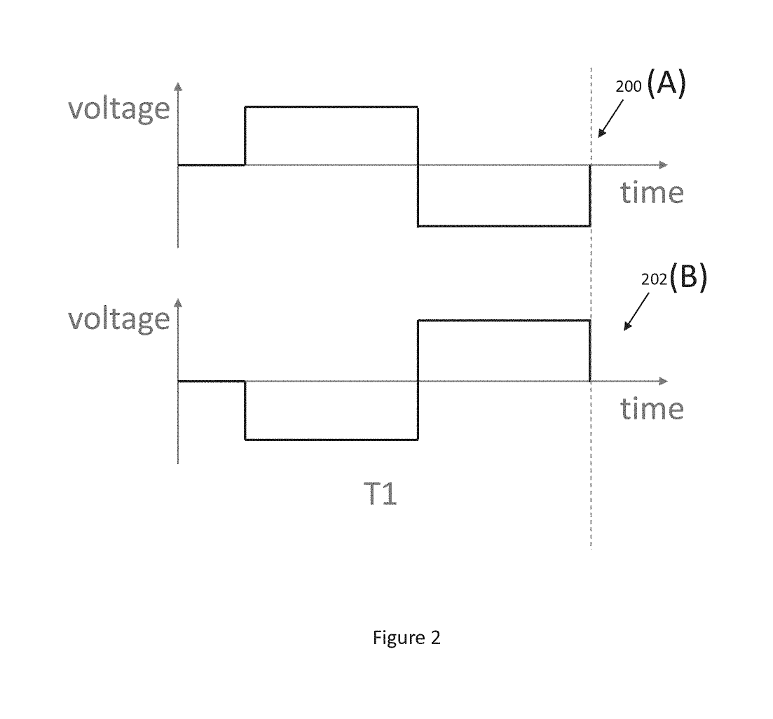

In operation, when the display pixel 100 is being addressed (i.e., pixel TFT in conduction), driving voltage signals (i.e., waveforms) or voltage lists are transferred from the data line 106 to the pixel electrode 104. However, problems can arise when while the display pixel 100 is being driven with one set of voltage list (e.g., Voltage list A or waveform A 200 illustrated in FIG. 2) and the adjacent pixel (not shown) is driven by another set of voltage list or waveform (e.g., Voltage list B or waveform B 202). This driving configuration, because of the overlapping of different waveform or voltage values present in the two data liens 106 and 108, will cause differentiating and disruptive capacitive couplings and/or cross-talks between the data lines 106, 108 and the pixel electrode 104, which in term resulting in the voltage values of the pixel electrode 104 to shift in an undesired fashion, causing image artifacts such as streaking.

As described above, the capacitive coupling between the data lines 106, 108 and the pixel electrode 104 creates undesirable cross-talks and such cross-talks can lead to unwanted voltage shifts that in turn will lead to unwanted optical transitions. One way to reduce such crosstalk and/or voltage shift is by time shift the voltage lists supplied through one of the data lines (e.g., date line 106) (e.g., to avoid the overlapping of the different voltage values in adjacent data lines), which is described in more details below.

FIG. 2 illustrates two exemplary voltage lists A and B discussed above that may be transmitted or supplied to display pixels using the data lines presented in FIG. 1. In use, an electro-optic display such as an electrophoretic display will typically have multiple rows and columns of display pixels, where each row or column of display pixels may share a gate line (e.g., gate line 102 illustrated in FIG. 1) and may be activated by this gate line. For the purpose of explaining the concepts illustrated herein, Voltage List A 200 may be a set of waveforms applied to a first column of display pixels to bring the pixels to a desired grayscale level, and Voltage list B 202 may be a set of voltages applied to a second column of display pixels. As shown in FIG. 2, Voltage lists A 200 and B 202 are to be transmitted with a time frame T1 to the pixel rows A and B. In operation, pixel rows A or B will be selectively turned on and off during this time frame T1 while data line 106 transmits the corresponding voltage list to the selected pixel row. However, cross talk and voltage shifts will occur under such bias scheme even when both columns are selected and driven, the waveforms being transmitted through the data line 106 and 108 will have different values and overlap in time and resulting in unwanted crosstalk.

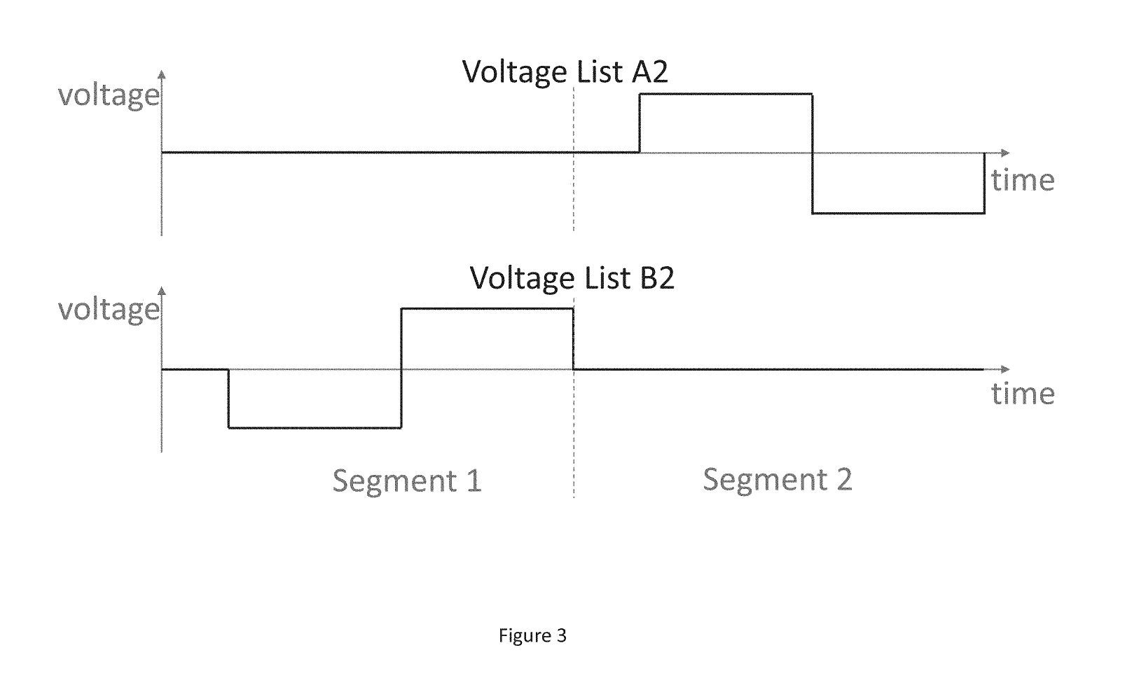

To remedy such deficiency in the display driving scheme, FIG. 3 illustrates a shifting of the voltage lists shown in FIG. 2 in accordance with the subject matter disclosed herein for the purpose of reducing the crosstalk. In practice, each set of waveform or voltage list can include at least one active portion configured to change or affect the optical state of the display pixel, and at least one non-active portion configured not to substantially affect or change the optical of the display pixel. In some embodiments, the non-active portions may be a zero volt segment where no waveform or voltage bias is applied to the pixel. In an exemplary configuration shown in FIG. 3, a segment of the zero volts are added to segment 2, or the active portion, of voltage list A, effectively creating a new voltage list A2. Similarly, a segment of zero volts are added to segment 1, also the active portion, of voltage list B, effectively creating the new voltage list B2, where such zero volt segment causes almost no optical transition or grayscale shift in the pixel. It should be appreciated that this is possible to do with electrophoretic displays (EPD) because the physical nature of the EPDs dictates that even under a zero bias potential across the EPD's display medium, its display pixels are capable of maintaining their prior optical states. In this fashion, bias voltages from the original voltage lists A and B may be separated in time, and as such, cross-talks and voltage shifts in pixel electrodes may be greatly reduced. In practice, the voltage lists in each segments may be determined through a selection process tailored to each electro-optic displays.

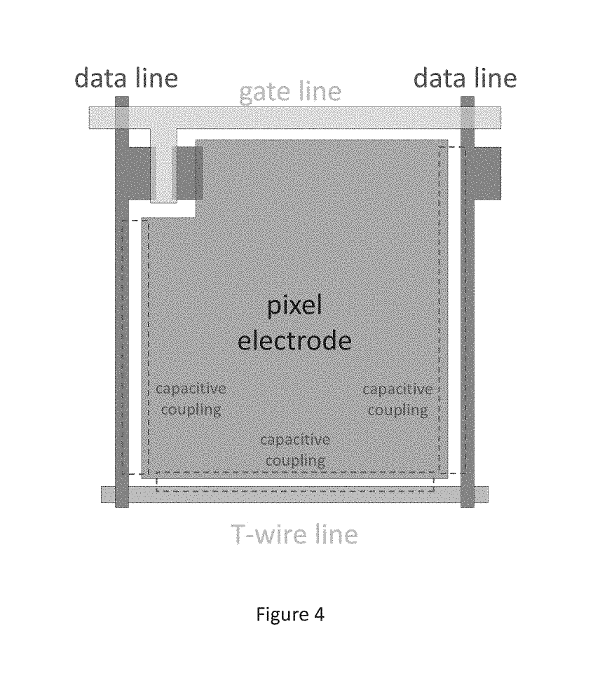

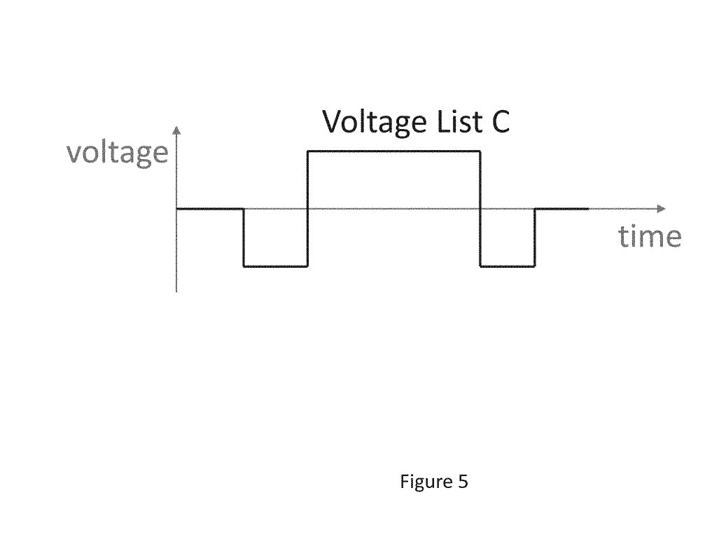

In some other embodiments, a TFT backplane for driving an electrophoretic display may comprise an additional bias line (e.g., T-wire line) as illustrated in FIG. 4. The T-wire line may be configured to connect the source driver outputs to data lines. FIG. 5 illustrates an exemplary Voltage List C that may be applied through the T-wire line to selectively switch the rows of display pixels. This Voltage List C, when applied during the same time frame as the Voltage List A and B, will introduce additional voltage shifts to the display pixels. Similar to the configuration illustrated in FIG. 3, the Voltage List C may be time shifted such that its active biasing portion is at a different time segment from Voltage List A and B. Accordingly, capacitive coupling due to Voltage List C may be minimized.

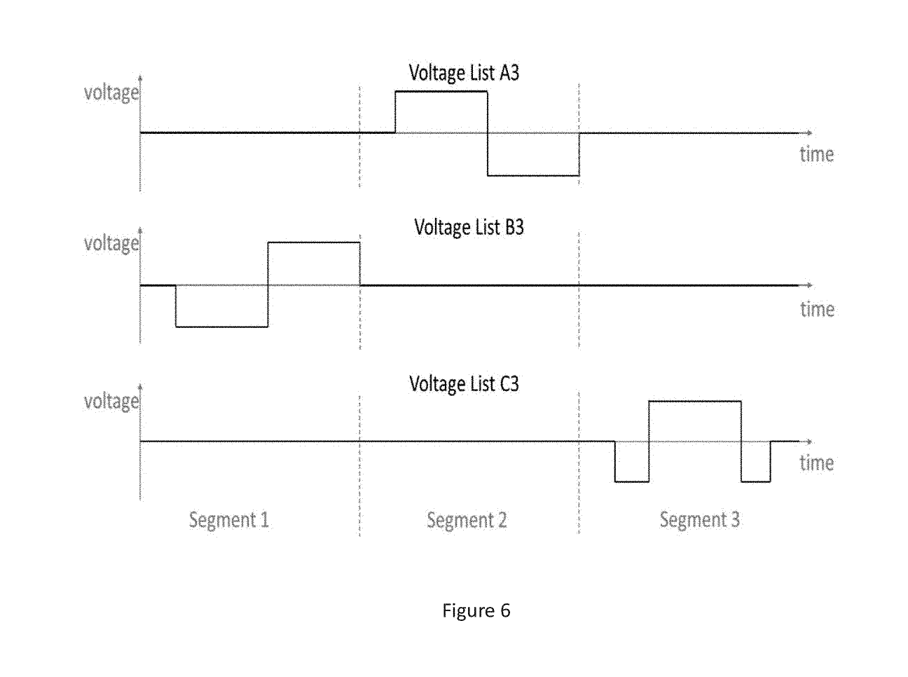

In practice, the voltage list applied to the t-wire will be applied to both the display pixel 104 and its adjacent display pixel (not shown). In this case, all three voltage lists discussed above (i.e., voltage lists A, B, and C) may be time shifted such that their active portions do not overlap each other in the time domain. FIG. 6 illustrate a such driving scheme where three voltage lists are time shifted, such that the non-zero driving or active portions of the driving lists are separated in the time domain (e.g., Voltage list A3 in segment 2, Voltage list B3 in segment 1, and Voltage list C3 in segment 3) to reduce crosstalk. It should be appreciated that the concept illustrated herein may be conveniently adopted to driving schemes with a large number of voltage lists (e.g., 256), where each voltage list may be time shifted to reduce crosstalk.

It will be apparent to those skilled in the art that numerous changes and modifications can be made in the specific embodiments of the invention described above without departing from the scope of the invention. Accordingly, the whole of the foregoing description is to be interpreted in an illustrative and not in a limitative sense.

1. A method for driving an electro-optic display having a plurality of display pixels, the method comprising:
applying a first set of waveform to a first display pixel, the first set of waveform having at least one active portion configured to affect the optical state of the first display pixel and at least one non-active portion configured not to substantially affect the optical state of the first display pixel; and
applying a second set of waveform to a second display pixel, the second set of waveform having at least one active portion configured to affect the optical state of the second display pixel and at least one non-active portion configured not to substantially affect the optical state of the second display pixel;
wherein the at least one active portions of the first and second set of waveforms do not overlap in time.

2. The method of claim 1, wherein the first and second display pixels are positioned adjacent to one another.

3. The method of claim 1, wherein the at least one active portions of the first and second set of waveform have opposite voltage values.

4. The method of claim 1, wherein the at least one non-active portion of the first set of waveform is a zero volt segment.

5. The method of claim 1, wherein the at least one non-active portion of the second set of waveform is a zero volt segment.

6. The method of claim 1 further comprising applying a third set of waveform to the first and second display pixels, wherein the third set of wave form having at least one active portion configured to affect the optical state of the first and second display pixels and at least one non-active portion configured not to substantially affect the optical state of the first and second display pixels.

7. The method of claim 6 wherein the at least one active portions of the first, second and third set of waveforms do not overlap in time.
